(19) United States
(12) Patent Application Publication
(10) Pub. No.: US 2018/0001212 A1
(43) Pub. Date: Jan. 4, 2018

(54) PLAYER RATING SYSTEM FOR MULTIPLAYER ONLINE COMPUTER GAMES

(71) Applicant: Zynga Inc., San Francisco, CA (US)

(72) Inventors: Jarred Wesley Simmer, San Francisco, CA (US); Jason Eugene Orcutt, San Bruno, CA (US)

(21) Appl. No.: 15/199,342

(22) Filed: Jun. 30, 2016

(51) Int. Cl. A63F 13/798; A63F 13/35

(52) U.S. Cl. CPC A63F 13/798; A63F 13/35

(57) ABSTRACT

In example embodiments, a method of rating skill levels of players of a game executing on a game networking system is disclosed. An event within a game is identified as corresponding to a combination of head-to-head mini games between a subset of a plurality of players of the game. For each of the combinations of head-to-head mini games, a result of the mini game is determined and a first rating and a second rating are updated, the first rating corresponding to a first player and the second rating corresponding to the second player. An aspect of the game networking system is adapted based on the updating of the first rating and the second rating.

### TECHNICAL FIELD

The present disclosure generally relates to computer-implemented games and, in one specific example, to improving a player rating system for multi player online computer games.

### BACKGROUND

A game networking system may support one or more online computer games that involve player-versus-player competitions. Based on the results of the competitions, players can be rated against one another. For example, the Elo rating system is a rating system that estimates the relative skill levels of players in chess based on their wins and losses in chess. Similarly, the Elo rating system can also be used to predict the winner of head-to-head team matchups in sports, such as baseball, basketball, football, or soccer. The Elo rating system has also been used in other ways, such as in soft biometrics, biology, computer automation, and computer vision applications.

### BRIEF DESCRIPTION OF THE DRAWINGS

Some embodiments are illustrated by way of example and not limitation in the figures of the accompanying drawings in which:

FIG. 1 is a block diagram illustrating an example of a system for implementing various disclosed embodiments;

FIG. 2 is a block diagram illustrating an example modules of the game networking system of FIG. 1;

FIG. 3 is a block diagram of an example method of implementing an improved player rating system;

FIG. 4 is a block diagram of an example method of adjusting player ratings after the completion of a mini game;

FIG. 5 is a block diagram of an example method of determining the k-factor for a specific game;

FIG. 6 is a block diagram of an example method of using player ratings to control matchmaking within a game;

FIG. 7 is a screen shot of an example user interface of a multiplayer online computer game;

FIG. 8 is a block diagram illustrating an example data flow between the components of a system;

FIG. 9 is a block diagram illustrating an example network environment in which various example embodiments may operate; and

FIG. 10 is a block diagram illustrating an example computing system architecture that may be used to implement a server or a client system.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

In example embodiments, a method of rating skill levels of players of a game executing on a game networking system is disclosed. An event within a game is identified as corresponding to a combination of head-to-head mini games between a subset of a plurality of players of the game. For each of the combinations of head-to-head mini games, a result of the mini game is determined and a first rating and a second rating are updated, the first rating corresponding to the first player and the second rating corresponding to the second player. An aspect of the game networking system is adapted based on the updating of the first rating and the second rating.

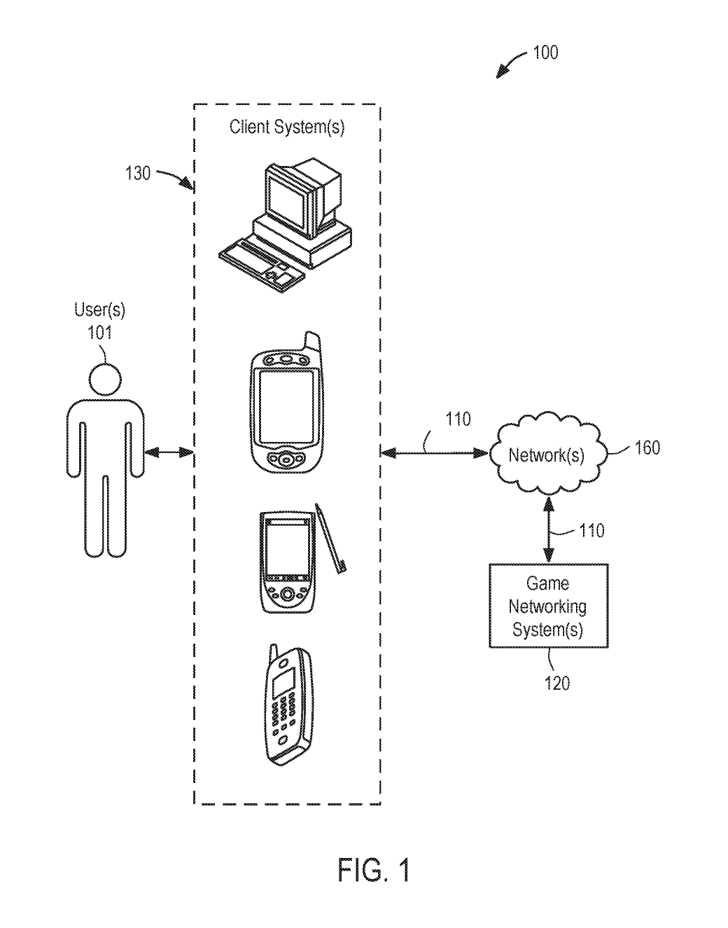

FIG. 1 is a block diagram illustrating an example of a system 100 for implementing various disclosed embodiments. In particular embodiments, system 100 comprises user(s) 101, game networking system(s) 120, client system(s) 130, and network(s) 160. The one or more users(s) 101 may also be referred to as one or more player(s); and the player(s) may also be referred to as the user(s) 101. The components of system 100 can be connected to each other in any suitable configuration, using any suitable type of connection. The components may be connected directly or over network(s) 160, which may be any suitable network. For example, one or more portions of network(s) 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Game networking system(s) 120 is a network-addressable computing system that can host one or more online games. Game networking system(s) 120 can generate, store, receive, and transmit game-related data, such as, for example, game account data, game input, game state data, and game displays. Game networking system(s) 120 can be accessed by the other components of system 100 either directly or via network(s) 160. Players (e.g., user(s) 101) may use client system(s) 130 to access, send data to, and receive data from game networking system(s) 120. Client system(s) 130 can access game networking system(s) 120 directly, via network 160, or via a third-party system. Client system(s) 130 can be any suitable computing device, such as a personal computer, laptop, cellular phone, smart phone, computing tablet, and the like.

Although FIG. 1 illustrates a particular number of user(s) 101, game networking system(s) 120, client system(s) 130, and network(s) 160, this disclosure contemplates any suitable number of users 101, game networking systems 120, client systems 130, and networks 160. Although FIG. 1 illustrates a particular arrangement of user(s) 101, game networking system(s) 120, client system(s) 130, and network(s) 160, this disclosure contemplates any suitable arrangement of user(s) 101, game networking system(s) 120, client system(s) 130, and network(s) 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include one or more of an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between user(s) 101, game networking system(s) 120, client system(s) 130, and network(s) 160, this disclosure contemplates any suitable connections between user(s) 101, game networking system(s) 120, client system(s) 130, and network(s) 160. As an example and not by way of limitation, in particular embodiments, client system(s) 130 may have a direct connection to game networking system(s) 120, thereby bypassing network(s) 160.

### Online Games and Game Systems

### Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each player (e.g., user 101) controls one or more player characters (PCs). The game engine controls all other aspects of the game, including NPCs and in-game objects. The game engine also manages game state, including player character state for currently active (e.g., online) and inactive (e.g., offline) players.

An online game can be hosted by game networking system(s) 120, which can be accessed using any suitable connection with a suitable client system(s) 130. A player may have a game account on game networking system(s) 120, wherein the game account can contain a variety of information associated with the player (e.g., the player's personal information, financial information, purchase history, player character state, game state, etc.). In some embodiments, a player may play multiple games on game networking system(s) 120, which may maintain a single game account for the player with respect to all the games, or multiple individual game accounts for each game with respect to the player. In some embodiments, game networking system(s) 120 can assign a unique identifier to each user 101 of an online game hosted on game networking system(s) 120. Game networking system(s) 120 can determine that a user 101 is accessing the online game by reading the user's 101 cookies, which may be appended to Hypertext Transfer Protocol (HTTP) requests transmitted by client system(s) 130, and/or by the user 101 logging onto the online game.

In particular embodiments, user(s) 101 may access an online game and control the game's progress via client system(s) 130 (e.g., by inputting commands to the game at the client device). Client system(s) 130 can display the game interface, receive inputs from user(s) 101, transmit user inputs or other events to the game engine, and receive instructions from the game engine. The game engine can be executed on any suitable system (such as, for example, client system(s) 130, or game networking system(s) 120). As an example and not by way of limitation, client system(s) 130 can download client components of an online game, which are executed locally, while a remote game server, such as game networking system(s) 120, provides backend support for the client components and may be responsible for maintaining application data of the game, processing the inputs from the player, updating and/or synchronizing the game state based on the game logic and each input from the player, and transmitting instructions to client system(s) 130. As another example and not by way of limitation, each time a player (e.g., a user 101) provides an input to the game through the client system(s) 130 (such as, for example, by typing on the keyboard or clicking the mouse of client system(s) 130), the client components of the game may transmit the player's input to game networking system(s) 120.

In many computer games, there are various types of in-game assets (aka “rewards” or “loot”) that a player character can obtain within the game. For example, a player character may acquire game points, gold coins, experience points, character levels, character attributes, virtual cash, game keys, or other in-game items of value. In many computer games, there are also various types of in-game obstacles that a player must overcome to advance within the game. In-game obstacles can include tasks, puzzles, opponents, levels, gates, actions, and so forth. In some games, a goal of the game may be to acquire certain in-game assets, which can then be used to complete in-game tasks or to overcome certain in-game obstacles. For example, a player may be able to acquire a virtual key (i.e., the in-game asset) that can then be used to open a virtual door (i.e., the in-game obstacle).

### Game Systems, Social Networks, and Social Graphs

In an online multiplayer game, players may control player characters (PCs) and a game engine controls non-player characters (NPCs) and game features. The game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player.

In particular embodiments, user(s) 101 may access particular game instances of an online game. A game instance is a copy of a specific game play area that is created during runtime. In particular embodiments, a game instance is a discrete game play area where one or more user(s) 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more user(s) 101 and one or more in-game objects controlled by the game engine. When accessing an online game, the game engine may allow user(s) 101 to select a particular game instance to play from a plurality of game instances. Alternatively, the game engine may automatically select the game instance that user(s) 101 will access. In particular embodiments, an online game comprises only one game instance that all user(s) 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multi player game, though this disclosure contemplates any suitable social graph users.

The minimum number of edges required to connect a player (or player character) to another user is considered the degree of separation between them. For example, where the player and another user are directly connected (one edge), they are deemed to be separated by one degree of separation. The other user would be a so-called “first-degree friend” of the player. Where the player and the other user are connected through one other user (two edges), they are deemed to be separated by two degrees of separation. The other user would be a so-called “second-degree friend” of the player. Where the player and the other user are connected through N edges (or N-1 other users), they are deemed to be separated by N degrees of separation. The other user would be a so-called “Nth-degree friend.” As used herein, the term “friend” means only first-degree friends, unless context suggests otherwise.

Within the social graph, each player (or player character) has a social network. A player's social network includes all users in the social graph within Nmax degrees of the player, where Nmax is the maximum degree of separation allowed by the system managing the social graph (such as, for example, game networking system(s) 120). In one embodiment, Nmax equals 1, such that the player's social network includes only first-degree friends. In another embodiment, Nmax is unlimited and the player's social network is coextensive with the social graph.

In particular embodiments, the social graph is managed by game networking system(s) 120, which is managed by the game operator. In other embodiments, the social graph is part of a social networking system managed by a third-party (e.g., Facebook or Snapchat). In yet other embodiments, user 101 has a social network on both game networking system(s) 120 and a social networking system, wherein user's) 101 can have a social network on the game networking system(s) 120 that is a subset, superset, or independent of the user's 101 social network on the social networking system. In such combined systems, game networking system(s) 120 can maintain social graph information with edge type attributes that indicate whether a given friend is an “in-game friend,” an “out-of-game friend,” or both. The various embodiments disclosed herein are operable when the social graph is managed by the social networking system, game networking system(s) 120, or both.

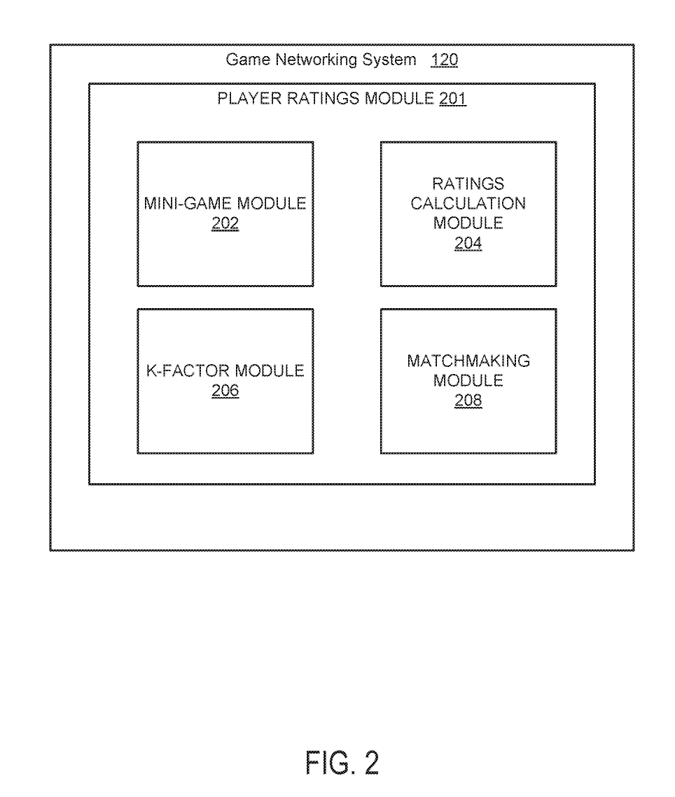

FIG. 2 is a block diagram illustrating an example player ratings module 201 of the game networking system 120. The player ratings module 201 is configured to calculate player ratings and modify an aspect of the game networking system based on the calculated player ratings. In example embodiments player ratings module 201 includes mini-game module 202. The mini-game module 202 is configured to identify when a mini game is occurring between two players based on definitions defining the mini game. A ratings calculation module 204 is configured to assign initial ratings to new players and calculate new ratings for each player participating in a mini game upon completion of the mini game. A k-factor module 206 is configured to calculate a k factor for controlling the impact of the result of a mini game on each player who participated in the mini game. A matchmaking module 208 is configured to incorporate each player's rating into a matchmaking aspect of the game.

### Improved Player Rating System

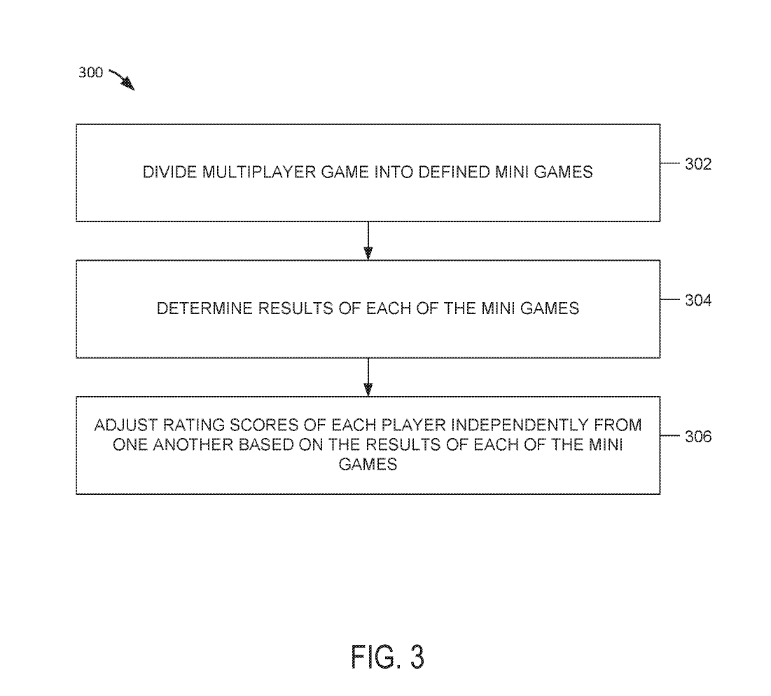

FIG. 3 is a block diagram of an example method 300 of implementing an improved player rating system. In various embodiments, the method 300 may be performed by the mini game module 202.

At operation 302, a computer game having multiple simultaneous competitors is divided into mini games. In various embodiments, the mini games are determined (e.g., based on natural occurrences or pre-defined occurrences within the game in which a subset of the players are temporarily pitted against one another in a sub-competition and for which a winner of the sub-competition can be determined). In various embodiments, the sub-competitions may be reduced to head-to-head competitions from competitions involving a larger subset of the simultaneous players. In various embodiments, the rating system considers combinations of mini games in which each player has played against every other player exactly once.

As an example, consider an online poker game having nine players. In various embodiments, one or more players may post a blind bet prior to any cards being dealt. For example, in Texas Hold 'Em, there may typically be a “small blind” and a “big blind” posted by two players at the beginning of each round. Any player who posts a blind bet, as well as any player who posts a bet during the round (e.g., after the hole cards are dealt, the flop is dealt, the turn is dealt, or the river is dealt), could be considered as a participant in a mini game between each of the other participants in the round. However, players who do not place a bet during the round may not be considered as participants. The mini game may be a sub-competition between each of the participants. The sub-competition may defined in a particular way (e.g., it may have particular rules, including different rules from the game of which it forms a part, such as determining whether a first player beat a second player based on a relative number of chips won or lost in a round of a game, as discussed in more detail below). In various embodiments, the mini game is defined as occurring between two different points of the game (e.g., a beginning of a round of poker to the end of the round of poker) and for which each combination of participants during the two different points of the game can be determined to have beaten, lost to, or tied each of the other participants based on a result determination.

At operation 304, results of each mini-game are determined. In various embodiments, automatic result determination may be based on rules of the mini-game, such as system-generated or predefined rules. Such rules may include, for example, a first rule that a winner between a first player and a second player may be determined based on the first player winning chips and the second player losing chips. The rules may also include a second rule that a tie between a first player and a second player may be determined based on both the first player and the second player losing chips or both the first player and the second player winning chips.

For example, consider a round of Texas Hold 'Em Poker in which the only participants are a first player (e.g., who posted the small blind) and a second player (e.g., who posted a big blind). In the round, the first player raises and the second player folds; thus, the entire pot goes to the first player. In this example, it may be determined that the first player was the winner and the second player was the loser of the mini game.

As another example, consider a three-way pot involving a first player (e.g., who posted a small blind), a second player (e.g., who posted a big blind), and a third player (e.g., who made a bet after the hole cards were dealt to each player). Further assume the third player's bet is larger than the big blind and the first player and second player both elect to fold their hands. In this case, the mini games determined may comprise all combinations of results between the players. Based on the first rule, the result of a mini game between the third player and the first player is that the third player wins and the first player loses because the third player won chips and the first player lost chips. Additionally, for the same reason, the result of the mini game between the third player and the second player is also that the third player wins and the second player loses. Moreover, based on the second rule, the result of a mini game between the first player and the second player is a tie because both the first player and the second player lost chips. A game result determination may thus in such a case comprise assigning a binary win/loss outcome to each one of a plurality of overlapping pairs of players in a multiplayer mini-game, so that each player is determined to have a plurality of game outcomes for the mini-game (e.g., having a respective win/loss outcome with respect to each other participant in the multiplayer mini-game).

In alternative embodiments, automated result determination is based upon relative loss of chips between the players. For example, in an alternative embodiment, ties are assigned according to the second rule only when players win or lose the same number of chips. Additionally, the first rule may be modified such that a winner of a mini game is the player who wins the most chips. In this modified example, in the three-way pot described above, the first player will have beaten the second player based on the second player having lost more chips (e.g., because the first player lost the small blind bet, whereas the second player lost the big blind bet).

In alternative embodiments, with respect to an online poker game, automated result determination between two players may be based on factors other than the winning or losing of chips, such as good folds, good raises “bluffs”), and so on. The determination of whether a player makes a good fold or not may be based on various factors, such as the pot odds for a player (e.g., the size of the bet that the player is facing relative to the size of the pot and the odds of the player winning the hand) or risk of ruin (e.g., a percentage of the bet relative to the bankroll or chip stack of the player). In this case, the player who makes the good fold may be considered the winner and the player who makes the bad bet could be considered the loser. The determination of whether a player makes a good raise may similarly be based on various factors, such as the pot odds or risk of ruin. Thus, it may be determined that a player who is able to win a hand based on a bluff is the winner and the player who lost to the bluff is the loser of the mini game.

In various embodiments, specific rules may be selected to minimize system resources required to determine the winner. Thus, for example, simple rules pertaining to winning, losing, and tying, such as those based on whether players win or lose chips to each other, may be selected such that the winner of each mini game may be determined with minimal processor usage. Thus, simple rules may be preferred over other rules that may be a more accurate measure of the winner of each mini game. Additionally, rules that are more objective may be selected over rules that are more subjective with respect to determining a winner of a mini game. For example, a number of chips won or lost is an objective measure of the winner of a round of poker, whereas whether a player made a good fold or raise, depending on how it is calculated, may include subjective elements. Thus, in some embodiments, the number of chips won or lost may be a preferred measure of which player won a mini game.

While the automated result determination discussed above discusses the game of poker as an example, similar automation may be performed for any mini-game that occurs within a game, such as any sub-competition that can be defined and divided among participants in the normal course of playing a game. Additionally, any number of players could be included as participants. For example, the three-way pot discussed above could be expanded analogously to a four-way, five-way, or n-way pot, where n is the number of possible participants.

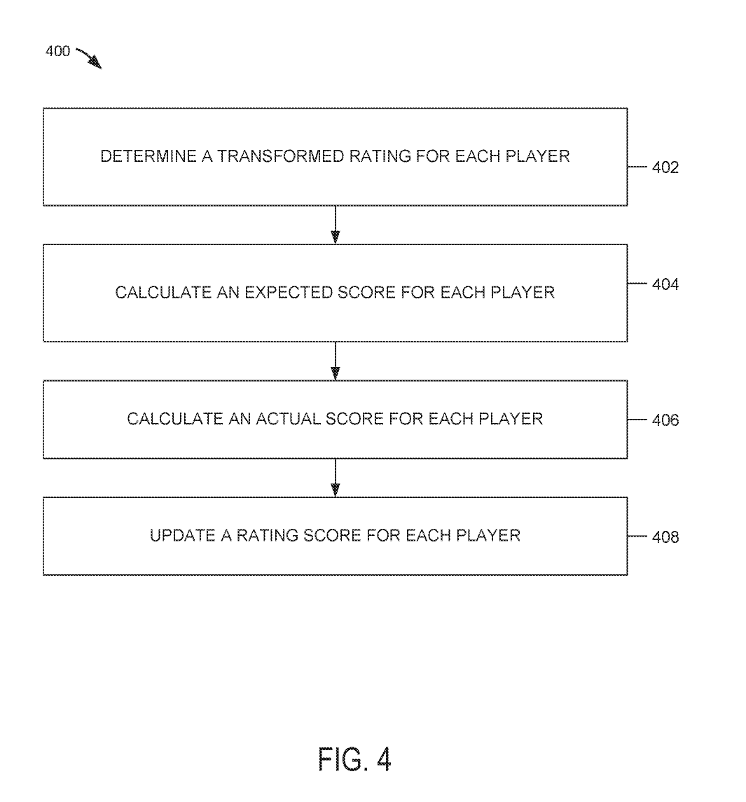

At operation 306, a player rating for a first player and a player rating for a second player are adjusted based on the results of a mini-game between the first player and the second player identifying a winner of the mini-game. In various embodiments, each player (e.g., as a brand new player) may be initially given a starting rating score, such as 1200. When a first player competes in a mini-game against a second player, assuming there is a winner, both the first player's rating score and the second player's rating score may increase or decrease. In various embodiments, the amount of the increase for each player may be based on specific calculations (see FIG. 4).

FIG. 4 is a block diagram of an example method 400 of adjusting player ratings after the completion of a mini game. In various embodiments, the method 400 may be performed by the ratings calculation module 204.

At operation 402, a transformed rating is computed for each player. For example, let r(1) represent the current score of player 1 and let r(2) represent the current rating of player 2. The transformed rating for player 1, A(1), may be represented as 10^{max(r(1), 1)/(starting score/3)}. The transformed rating for player 2, A(2), may be represented as 10^{max(r(2), 1)/(starting score/3)}.

At operation 404, an expected score is calculated for each player. For example, the expected score of player 1 playing against player 2, E(1,2), be A(1)/(A(1)+A(2)) and the expected score of player 2 playing against player 2, E(2,1), may be A(2)/(A(1)+A(2)).

At operation 406, an actual score is set for each player based on the determined result of the mini-game. For example, the actual score for player 1 playing against player 2, S(1,2), may be 1 if player 1 wins against player 2, 0.5 if player 1 ties player 2, and 0 if player 1 loses to player 2. Similarly, the actual score for player 2 playing against player 1, S(2,1), may be 1 if player 2 wins against player 1, 0.5 if player 2 ties player 1, and 0 if player 2 loses to player 1.

At operation 408, the rating for each player is updated. For example, the updated rating for player 1 having played against player 2, r′(1,2), may be r(1)+k(1, 2, a)*(S(1,2)−E (1,2)). Similarly, the updated rating for player 2 having played against player 1, r′(2,1), may be r(2) k(2, 1, a)*(S(2, 1)−E(2, 1)).

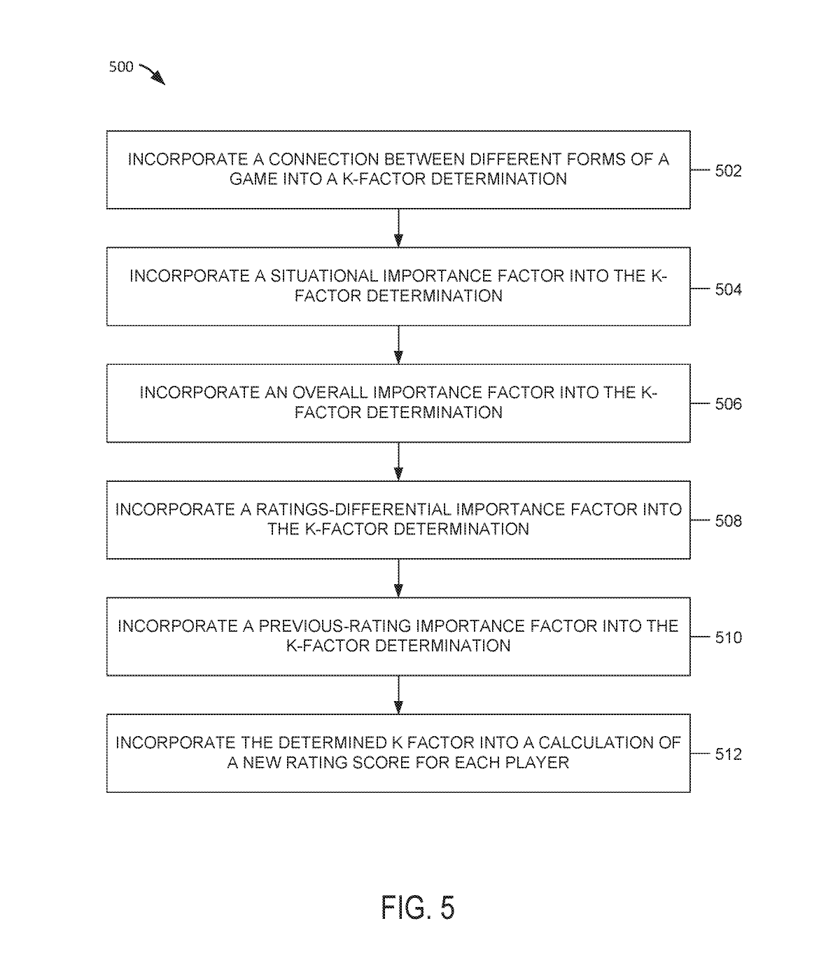

FIG. 5 is a block diagram of an example method 500 of determining the k-factor for a specific game. In various embodiments, the method 500 may be performed by the k-factor module 206.

In various embodiments, k represents an importance of a win. In various embodiments, k affects the amount by which a win or loss affects a player's score. In various embodiments, k can either be a constant or a variable.

In various embodiments, k may increase for a player as that player's rating score increases. The logic behind increasing k in this manner is that, as a player progresses to higher and higher rating scores, the odds of a loss to a lower opponent being caused by randomness rather than by skill differences increases. Thus, decreasing k for a player as the player's rating score increases accounts for an increase in skill certainty at higher rating scores.

The calculation of k may be optimized for particular games, such as gambling games or other games involving a significant element of short term luck. For example, in poker, it is a known (and often griped about) fact that even the most unskilled of players can win in the short term against even the best players in the world. Thus, the calculation of k for such games should value long-term gain over short-term wins.

Additionally, the calculation of k for such games should value high stakes wins over low stakes wins. For example, if player A raises all in 5 turns in a row and wins the blinds every time and player B notices this, waits for a good hand, and calls when appropriate in order to win, player B should be noted as the better player. This can be accomplished by increasing the importance of a win based on the number of chips that were won.

The same logic holds for playing at different stakes levels. If player A plays at a $2,000 buy-in game, wins 5 hands, then proceeds to go to a $1,000,000 buy-in game and lose 5 hands, he had a net losing day and his rating should be reflected as such. This, too, can be accomplished by increasing the importance of a win based on the number of chips that were won. This by itself does not explicitly grant better or worse ratings to equally skilled or bad play at higher stakes tables, but it does so implicitly since high stakes tables will have larger pots on average.

Moreover, the calculation of k can be used to comparably value different forms of a game for which the ratings scores are being used. For example, poker may be played by the same player in a tournament form or a cash form. In the tournament form, the player may purchase an initial set of chips and play until the player either wins the tournament or is eliminated. In the cash game form, the player may purchase and repurchase chips and play for an indefinite period of time. In various embodiments, a player's rating score may be designed to represent the player's skill at both forms of the game. For example, how does a player coming in 10th out of 100 in a $10,000 tournament compare to a player who won $10,000 at a cash game.

At operation 502, incorporate a connection between different forms of a game into the k factor. For example, the connection between the tournament game form of poker and the cash game form of poker is based on the determining a cash table value of a tournament chip. For example, if a player buys into a tournament for $1,000,000 and was given $2,000 in tournament chips to start, the cash table value of a single tournament chip is $500. In various embodiments, if a player can use re-buys and add-ons in a tournament, the cash table value of the single tournament chip is recalculated for the player upon the rebuy or add-on. Using the cash table value of tournament chips gives rating scores that incorporate tournament winnings and cash game winnings equally.

For example, let W(1,2) be an amount that player 1 won from player 2, Let W(2,1) be an amount that player 2 won from player 1. Let T_{B}(a) be a tournament ‘a’ buy-in amount. Let T_{S}(a) be a starting chip stack in tournament ‘a.’ the cash value of a single tournament chip in tournament ‘a,’ T_{V}(a), may then be calculated as T_{B}(a)/T_{S}(a).

At operation 504, a situational importance factor is incorporated into the k factor. For example, k′(1, 2, a) may be calculated as m*logₓ(max(|W(1, 2*T_{V}(a))/n*log_{z}(max(r(1), z))).

As x increases, the difference between the importance of small pot wins and large pot wins increases (big pots will matter more and more than smaller pots when determining updated ratings). The reason we take the max of W(1, 2)|*T_{V}(a) and x before taking the log is because if W(1, 2)|*T_{V}(a) is less than x, logₓ will be less than one. Even worse, if W(1, 2)|*T_{V}(a) is 0 (as will be the case in a tie), logₓ will be undefined.

At operation 506, an overall importance factor is incorporated into the k factor. As in increases, the importance of every win increases (all pots will matter more when determining updated ratings). In various embodiments, adjusting m can therefore take into account changes in the virtual economy associated with the game. For example, if, on a given day, players are awarded extra bonus chips and thus there are more chips in the virtual economy, m can be adjusted to reduce the importance of every win for that day.

At operation 508, an importance of the difference in ratings between the players is incorporated into the k factor. As z increases, the difference between the importance of high and low ranking players when determining updated ratings increases (high ranking players' ratings will update less and less than low ranking players' ratings). The reason we take the max of r(1) and z is because if r(1) is less than z, log_{z} will be less than 1. Even worse, if r(1) is 0, log_{z} will be undefined.

At operation 510, an importance factor of a previous rating when determining a new rating is incorporated into the k factor. As n increases, the importance of previous rating when determining new rating increases (everyone's current rating will matter more when determining the new rating).

At operation 512, the k factor is calculated based on the various factors described at operations 502-508 and incorporated into the calculation of new rating scores for each player (see FIGS. 4 and 5).

For example, m and n can be pulled out to give the following calculations:

k′(1, 2, a)=(m/n)*logₓ(|W(1, 2)|*T_{V}(a))/log_{z}(r(1))

p=m/n

k′(1, 2, a)=p*logₓ(|W(1, 2)|*T_{V}(a))/log_{z}(r(1))

k′(2, 1, a)=p*logₓ(|W(1, 2)|*T_{V}(a))/log_{z}(r(2))

k(1, 2, a)=k(2, 1, a)=min(k′(1, 2, a), k′(1, 2, a))

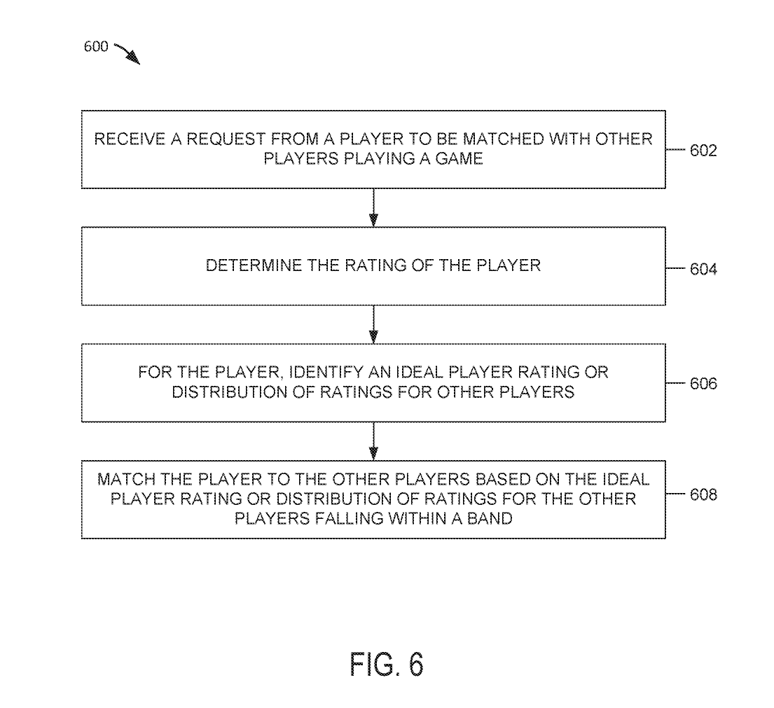

FIG. 6 is a block diagram of an example method 600 of using player ratings to control matchmaking within a game. In various embodiments, the method 600 may be performed by the matchmaking module 206.

At operation 602, a request from a player to join a game (e.g., a particular poker game having particular stakes) is received.

At operation 604, a player rating for the player is determined, as described above.

At operation 606, the player's rating is compared against the ratings of players at all of the games matching the request. For example, an ideal average player rating or distribution of player ratings is determined for the player based on information about the player and historical data. A band of player ratings or distribution of ratings is identified that includes a range surrounding the ideal rating or distribution of rating. By using a band, for example, the player may be provided with a variety of different opponents instead of the same set of opponents each time the player requests to be matched.

At operation 608, the player is placed in a game that corresponds to the band of player ratings or distribution of ratings that best suits the player's preferences and the goals of the operator in maximizing performance metrics associated with the game and that also satisfies the request received from the player. In various embodiments, if there is no band of player ratings or distribution of ratings that suit the player's preferences, the player may be seated by himself at a new table.

In various embodiments, historical data pertaining to games played may be analyzed to determine the significance of matchmaking with respect to player ratings and various performance metrics having significance to the operator of the game networking system, such as frequency of play (or return rate), amount of play, purchases made, complaints raised, types of actions performed within the games, and so on. Based on the analysis of the historical data, the matchmaking systems may be improved with respect to performance metrics associated with the game. For example, player ratings may be used to determine how to incentivize matching of paying players (e.g., those who have purchased chips) with non-paying players (those who use only free chips), thus improving the odds the paying players will make additional purchases with respect to the game.

In various embodiments, player ratings may be used to determine preferences of players with respect to the player ratings of other players that they are matched to play with. For example, if a paying player has a preference for playing lower rated players (e.g., as determined by differences in activity level of the player with respect to the game when playing against players having higher and lower skill ratings), the paying player may be matched against non-paying players with lower ratings. The optimizing of matching of non-paying players with paying players may be performed based on which matches are most likely to increase future investments of paying players in the game (e.g., based on historical analysis).

As another example, it may be determined that certain types of players (e.g., new players) may have a preference for playing against other players having skill levels that are either far below or far higher than their own, but not against players having the same skill level. For example, new players may prefer a higher “risk” for the game and find that playing players of the same skill is boring. These players may then be placed into games via the matchmaking modules such that their opponent preference is maximized with respect to the game. On the other hand, regular players who are no longer “new” may have a preference for playing against players having a similar player rating. Thus, these regular players may be matched differently than new players so as to maximize their enjoyment or improve overall performance metrics associated with the game.

In various embodiments, the player ratings module 201 may be used in conjunction with other modules of the game networking system (e.g., via the applications module 208) for various applications. For example, other modules of the game networking system may be used to detect fraudulent accounts within the game networking system. Fraudulent account detection may include identifying whether accounts are associated with potentially bad actors, such as people who use a bot to come into a game to collect chips and gift them to another player or another bot by intentionally losing. They may accumulate chips in an account and then sell the chips or the account to another person, which is an action that may be contrary to terms of use of the game networking system.

The other modules may also be used to detect collusion within a game, which can cause a bad experience for other users of the game networking system, and reduce their level of play with respect to the game (and thus revenues associated with the game).

By incorporating player ratings, these various other modules of the game networking system may be improved. For example, the fraud detection modules may determine that players having certain player ratings are more likely to be associated with accounts that are being used for fraudulent purposes or for collusion within a game. The player ratings for each player may be compared to average player ratings for similar players. These similar players may be identified based on any characteristics of the players, such as hands played, length of time playing per day, number of games played, and so on. Through detection of players having ratings that are outliers with respect to average similar players, the system may be able to flag those players as potentially bad actors or even automatically block accounts of the players based on the outlier detection.

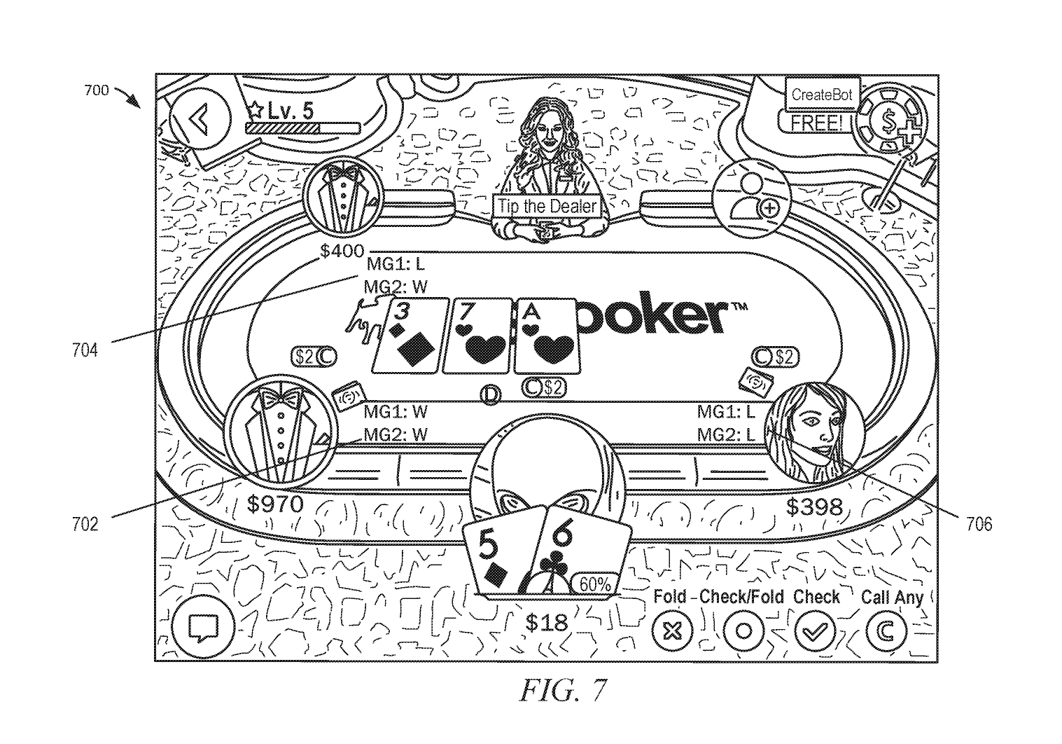

FIG. 7 is a screen shot of an example user interface 700 of a multiplayer online computer game. The user interface 700 includes user interface elements 702, 704, and 706, which provide information pertaining to mini games that are currently in progress. User interface element 702 indicates that a first player (i.e., the player who wagered $970) is a winning a first mini game (i.e., between the first player and a second player, who wagered $400) and that the first player is also currently winning a second mini game (i.e., between the first player and a third player, who wagered $398). In other words, if second player and the third player both fold their hands to the first player's bet, then the results of the mini games for each of the players will he as depicted in user interface elements 702, 704, and 706. User interface element 704 indicates that the second player will lose the first mini game (between the first player and the second player), but will win the second mini game (between the second player and the third player. User interface element 706 indicates that the third player will lost both mini games. Here, the mini games are defined as sub-competitions between each of the participants in a round of poker and whether a player wins or loses depends on how many chips they win or lose relative to the other participants.

Depending on the actions taken by each player, the predicted outcome of each mini game would change along with the corresponding depictions in the user interface elements 702, 704, and 706. For example, if the second player realises, his predicted outcome would change to a win for both mini games and the first players predicted outcome would change to a lost for the first mini game and a win for the second mini game.

In example embodiments, the user interface elements may include an indicator of a player rating of each player as well as a depiction of an effect of a win or loss of each mini game on the player's overall rating. In example embodiments, the player is not shown his actual player rating, but rather a separate depiction of an approximation of that player's rating, such as a tier (and level within the tier) (bronze 5, silver 4, gold 2) and so on and how a win or loss of a set of mini games will have an overall effect on the player's tier or level.

### Data Flow

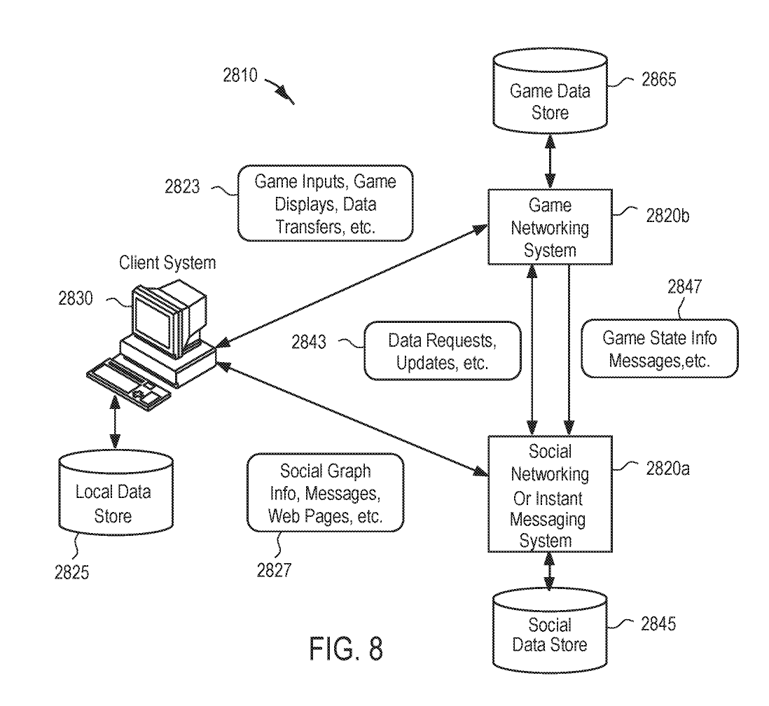

FIG. 8 is a block diagram illustrating an example data flow between the components of system 2810. In particular embodiments, system 2810 can include client system 2830, social networking system 2820a, and game networking system 2820b. The components of system 2810 can be connected to each other in any suitable configuration, using any suitable type of connection. The components may be connected directly or over any suitable network. Client system 2830, social networking system 2820a, and game networking system 2820b can each have one or more corresponding data stores such as local data store 2825, social data store 2845, and game data store 2865, respectively. Social networking system 2820a and game networking system 2820b can also have one or more servers that can communicate with client system 2830 over an appropriate network. Social networking system 2820a and game networking system 2820b can have, for example, one or more internet servers for communicating with client system 2830 via the Internet. Similarly, social networking system 2820a and game networking system 2820b can have one or more mobile servers for communicating with client system 2830 via a mobile network (e.g., GSM, PCS, Wi-Fi, WPAN, etc.). In some embodiments, one server may be able to communicate with client system 2830 over both the Internet and a mobile network. In other embodiments, separate servers can be used.

Client system 2830 can receive and transmit data 2823 to and from game networking system 2820b. This data can include, for example, webpages, messages, game inputs, game displays, HTTP packets, data requests, transaction information, updates, and other suitable data. At some other time, or at the same time, game networking system 2820b can communicate data 2843, 2847 (e.g., game state information, game system account information, page info, messages, data requests, updates, etc.) with other networking systems, such as social networking system 2820a (e.g., Facebook, Myspace, etc.). Client system 2830 can also receive and transmit data 2827 to and from social networking system 2820a. This data can include, for example, webpages, messages, social graph information, social network displays, HTTP packets, data requests, transaction information, updates, and other suitable data.

Communication between client system 2830, social networking system 2820a, and game networking system 2820b can occur over any appropriate electronic communication medium or network using any suitable communications protocols. For example, client system 2830, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP and other communications protocols, such as HTTP-S, FTP, SNMP, TELNET, and a number of other protocols may be used). In addition, a server in one interaction context may be a client in another interaction context. In particular embodiments, the information transmitted between hosts may be formatted as HTML documents. Other structured document languages or formats can be used, such as XML and the like. Executable code objects, such as Java Script and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 2820b, the BLOB containing the game state for the instance corresponding to the player can be transmitted to client system 2830 for use by a client-side executed object to process. In particular embodiments, the client-side executable may be a Flash-based game, which can de-serialize the game state data in the BLOB. As a player plays the game, the game logic implemented at client system 2830 maintains and modifies the various game state parameters locally. The client-side game logic may also batch game events, such as mouse clicks, and transmit these events to game networking system 2820b. Game networking system 2820b may itself operate by retrieving a copy of the BLOB from a database or an intermediate memory cache (memcache) layer. Game networking system 2820b can also de-serialize the BLOB to resolve the game state parameters and execute its own game logic based on the events in the batch file of events transmitted by the client to synchronize the game state on the server side. Game networking system 2820b may then re-serialize the game state, now modified, into a BLOB and pass this to a memory cache layer for lazy updates to a persistent database.

With a client-server environment in which the online games may run, one server system, such as game networking system 2820b, may support multiple client systems 2830. At any given time, there may be multiple players at multiple client systems 2830 all playing the same online game. In practice, the number of players playing the same game at the same time may be very large. As the game progresses with each player, multiple players may provide different inputs to the online game at their respective client systems 2830, and multiple client systems 2830 may transmit multiple player inputs and/or game events to game networking system 2820b for further processing. In addition, multiple client systems 2830 may transmit other types of application data to game networking system 2820b.

In particular embodiments, a computer-implemented game may be a text-based or turn-based game implemented as a series of web pages that are generated after a player selects one or more actions to perform. The web pages may be displayed in a browser client executed on client system 2830. As an example and not by way of limitation, a client application downloaded to client system 2830 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF object that is embedded in a web page and executable by a Flash media player plug-in. In particular embodiments, one or more described webpages may be associated with or accessed by social networking system 2820a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 2830, either caused by an action of a game player or by the game logic itself, client system 2830 may need to inform game networking system 2820b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 2810 is discussed in reference to updating a multi-player online game hosted on a network-addressable system (such as, for example, social networking system 2820a or game networking system 2820b), where an instance of the online game is executed remotely on a client system 2830, which then transmits application event data to the hosting system such that the remote game server synchronizes the game state associated with the instance executed by the client system 2830.

In a particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 2830 may include a Flash client. The Flash client may be configured to receive and run Flash applications or game object codes from any suitable networking system (such as, for example, social networking system 2820a or game networking system 2820b). In particular embodiments, the Flash client may be run in a browser client executed on client system 2830. A player can interact with Flash objects using client system 2830 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 2830, the Flash client may send the events that caused the game state changes to the in-game object to game networking system 2820b. However, to expedite the processing and hence the speed of the overall gaming experience, the Flash client may collect a batch of some number of events or updates into a batch file. The number of events or updates may be determined by the Flash client dynamically or determined by game networking system 2820b based on server loads or other factors. For example, client system 2830 may send a batch file to game networking system 2820b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 2830. In particular embodiments, the batch file may be a text file and the name-value pairs may be in string format.

In particular embodiments, when a player plays an online game on client system 2830, game networking system 2820b may serialize all the game-related data, including, for example and without limitation, game states, game events, and user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 2820b may retrieve the corresponding BLOB from the database to determine the most-recent values of the game-related data. In particular embodiments, while a player is playing the online game, game networking system 2820b may also load the corresponding BLOB into a memory cache so that the game networking system 120 may have faster access to the BLOB and the game-related data contained therein.

### Systems and Methods

In particular embodiments, one or more described webpages may be associated with a networking system or networking service. However, alternate embodiments may have application to the retrieval and rendering of structured documents hosted by any type of network-addressable resource or web site. Additionally, as used herein, a user may be an individual, a group, or an entity (such as a business or third-party application).

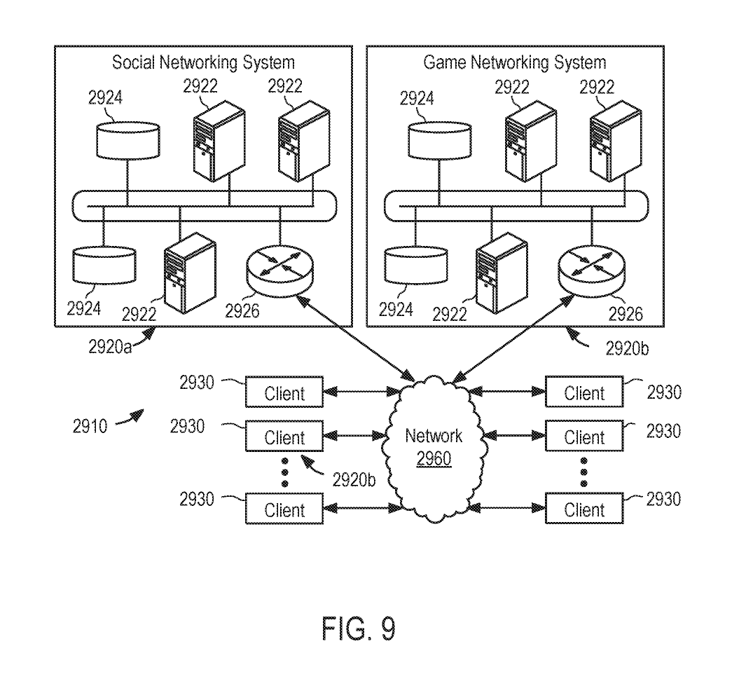

Particular embodiments may operate in a wide area network environment, such as the Internet, including multiple network-addressable systems. FIG. 9 is a block diagram illustrating an example network environment 2910, in which various example embodiments may operate. Network cloud 2960 generally represents one or more interconnected networks, over which the systems and hosts described herein can communicate. Network cloud 2960 may include packet-based WANs (such as the Internet), private networks, wireless networks, satellite networks, cellular networks, paging networks, and the like. As FIG. 9 illustrates, particular embodiments may operate in a network environment comprising one or more networking systems, such as social networking system 2920a, game networking system 2920b, and one or more client systems 2930. The components of social networking system 2920a and game networking system 2920b operate analogously; as such, hereinafter they may be referred to simply as networking system 2920. Client systems 2930 are operably connected to the network environment 2910 via a network service provider, a wireless carrier, or any other suitable means.

Networking system 2920 is a network-addressable system that, in various example embodiments, comprises one or more physical servers 2922 and data stores 2924. The one or more physical servers 2922 are operably connected to computer network 2960 via, by way of example, a set of routers and/or networking switches 2926. In an example embodiment, the functionality hosted by the one or more physical servers 2922 may include web or HTTP servers, FTP servers, application servers, as well as, without limitation, webpages and applications implemented using Common Gateway Interface (CGI) script, PHP Hyper-text Preprocessor (PHP), Active Server Pages (ASP), HTML, XML, Java, JavaScript, Asynchronous JavaScript and XML (AJAX), Flash, ActionScript, and the like.

Physical servers 2922 may host functionality directed to the operations of networking system 2920. Hereinafter servers 2922 may be referred to as server 2922, although server 2922 may include numerous servers hosting, for example, networking system 2920, as well as other content distribution servers, data stores, and databases. Data store 2924 may store content and data relating to, and enabling, operation of networking system 2920 as digital data objects. A data object, in particular embodiments, is an item of digital information typically stored or embodied in a data tile, database, or record. Content objects may take many forms, including: text (e.g., ASCII, SGML, HTML).) images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 2924 corresponds to one or more of a variety of separate and integrated databases, such as relational databases and object-oriented databases, that maintain information as an integrated collection of logically related records or files stored on one or more physical systems. Structurally, data store 2924 may generally include one or more of a large class of data storage and management systems. In particular embodiments, data store 2924 may be implemented by any suitable physical system(s) including components, such as one or more database servers, mass storage media, media library systems, storage area networks, data storage clouds, and the like. In one example embodiment, data store 2924 includes one or more servers, databases (e.g., MySQL), and/or data warehouses. Data store 2924 may include data associated with different networking system 2920 users and/or client systems 2930.

Client system 2930 is generally a computer or computing device including functionality for communicating (e.g., remotely) over a computer network. Client system 2930 may be a desktop computer, laptop computer, personal digital assistant (PDA), in- or out-of-car navigation system, smart phone or other cellular or mobile phone, or mobile gaming device, among other suitable computing devices. Client system 2930 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 2930 to enter addresses of specific network resources to be retrieved, such as resources hosted by networking system 2920. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 2930 desires to view a particular webpage (hereinafter also referred to as a target structured document) hosted by networking system 2920, the user's web browser, or other document rendering engine or suitable client application, formulates and transmits a request to networking system 2920. The request generally includes a URL or other document identifier as well as metadata or other information. By way of example, the request may include information identifying the user, such as a user identifier (ID), as well as information identifying or characterizing the web browser or operating system running on the user's client system 2930. The request may also include location information identifying a geographic location of the user's client system or a logical network location of the user's client system. The request may also include a timestamp identifying when the request was transmitted.

Although the example network environment 2910 described above and illustrated in FIG. 8 is described with respect to social networking system 2920a and game networking system 2920b, this disclosure encompasses any suitable network environment using any suitable systems. As an example and not by way of limitation, the network environment may include online media systems, online reviewing systems, online search engines, online advertising systems, or any combination of two or more such systems.

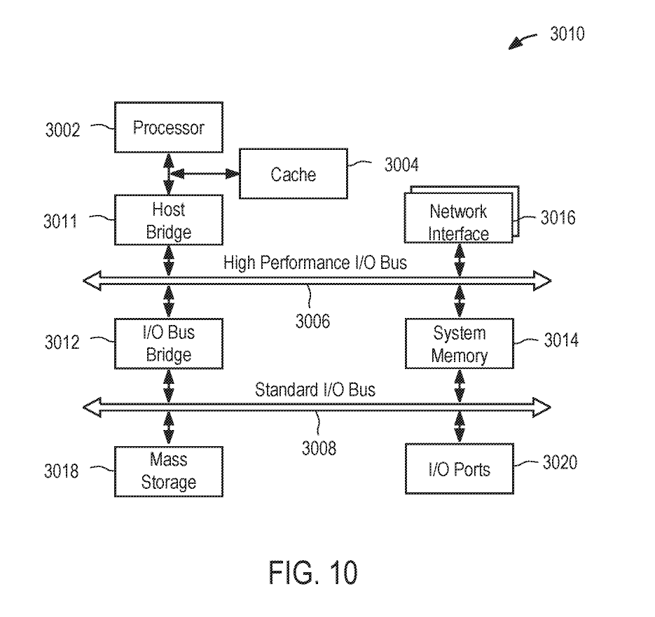

FIG. 10 is a block diagram illustrating an example computing system architecture, which may be used to implement a server 2922 or a client system 2930 (FIG. 9). In one embodiment, hardware system 3010 comprises a processor 3002, a cache memory 3004, and one or more executable modules and drivers, stored on a tangible computer-readable medium, directed to the functions or methodologies described herein. Additionally, hardware system 3010 may include a high performance input/output (I/O) bus 3006 and a standard I/O bus 3008. A host bridge 3011 may couple processor 3002 to high performance I/O bus 3006, whereas I/O bus bridge 3012 couples the two buses 3006 and 3008 to each other. A system memory 3014 and one or more network/communication interfaces 3016 may couple to bus 3006. Hardware system 3010 may further include video memory (not shown) and a display device coupled to the video memory. Mass storage 3018 and I/O ports 3020 may couple to bus 3008. Hardware system 3010 may optionally include a keyboard, a pointing device, and a display device (not shown) coupled to bus 3008. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 3010 are described in greater detail below. In particular, network interface 3016 provides communication between hardware system 3010 and any of a wide range of networks, such as an Ethernet (e.g., IEEE 802.3) network, a backplane, and so forth. Mass storage 3018 provides permanent storage for the data and programming instructions to perform the above-described functions implemented in servers 2922, whereas system memory 3014 (e.g., DRAM) provides temporary storage for the data and programming instructions when executed by processor 3002. I/O ports 3020 are one or more serial and/or parallel communication ports that provide communication between additional peripheral devices, which may be coupled to hardware system 3010.

Hardware system 3010 may include a variety of system architectures, and various components of hardware system 3010 may be rearranged. For example, cache memory 3004 may be on-chip with processor 3002. Alternatively, cache memory 3004 and processor 3002 may be packed together as a “processor module,” with processor 3002 being referred to as the “processor core.” Furthermore, certain embodiments of the present disclosure may not require nor include all of the above components. For example, the peripheral devices shown coupled to standard I/O bus 3008 may couple to high performance I/O bus 3006. In addition, in some embodiments, only a single bus may exist, with the components of hardware system 3010 being coupled to the single bus. Furthermore, hardware system 3010 may include additional components, such as additional processors, storage devices, or memories.

An operating system manages and controls the operation of hardware system 3010, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit. Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

### Miscellaneous

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding,” “locating,” “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, PDA, personal gaming device, etc.), that makes API calls directly to a server. Still further, while the embodiments described above operate with respect to a poker game, the embodiments can be applied to other games. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A system comprising:
one or more computer processors,
one or more memories including one or more instructions, the one or more instructions configuring the one or more computer processors to, at least:
identify that events within a game corresponds to a combination of head-to-head mini games between a subset of a plurality of players of the game;
for each of the combinations of head-to-head mini games:
determine a result of the mini game; and
update first rating and a second rating based on the result of the mini game, the first rating corresponding to a first player and the second rating corresponding to the second player; and
adapt an aspect of the game networking system based on the updating of the first rating and the second rating.

2. The system of claim 1, wherein the game is a poker game and the identifying that the events within the game correspond to a combination of head-to-head mini games is based on an identification that the subset of the plurality of players have placed a bet with respect to the game.

3. The system of claim 2, wherein the determining of the result of the mini game is based on a determination that the first player has beaten the second player if the first player won chips and the second player lost chips, the second player has beaten the first player if the second player won chips and the first player lost chips.

4. The system of claim 1, wherein the updating of the first rating and the updating of the second rating includes using a custom k-factor that incorporates at least one of a situational importance factor and overall importance factor.

5. The system of claim 1, wherein the updating of the first rating and the updating of the second rating includes using a custom k-factor that incorporates a connection between different forms of the game.

6. The system of claim 1, wherein the updating of the first rating and the updating of the second rating includes using a custom k-factor that incorporates a ratings-differential importance factor.

7. The system of claim 1, wherein adapting of the aspect of the game networking system includes adapting a matchmaking capability of the game to incorporate the updating of the first rating and the updating of the second rating.

8. A method comprising:
identifying that events within a game corresponds to a combination of head-to-head mini games between a subset of a plurality of players of the game;
for each of the combinations of head-to-head mini games:
determine a result of the mini game; and
update first rating and a second rating based on the result of the mini game, the first rating corresponding to a first player and the second rating corresponding to the second player; and
adapt an aspect of the game networking system based on the updating of the first rating and the second rating.

9. The method of claim 8, wherein the game is a poker game and the identifying that the events within the game correspond to a combination of head-to-head mini games is based on an identification that the subset of the plurality of players have placed a bet with respect to the game.

10. The method of claim 9, wherein the determining of the result of the mini game is based on a determination that the first player has beaten the second player if the first player won chips and the second player lost chips, the second player has beaten the first player if the second player won chips and the first player lost chips.

11. The method of claim 8, wherein the updating of the first rating and the updating of the second rating includes using a custom k-factor that incorporates at least one of a situational importance factor and overall importance factor.

12. The method of claim 8, wherein the updating of the first rating and the updating of the second rating includes using a custom k-factor that incorporates a connection between different forms of the game.

13. The method of claim 8, wherein the updating of the first rating and the updating of the second rating includes using a custom k-factor that incorporates a ratings-differential importance factor.

14. The method of claim 8, wherein adapting of the aspect of the game networking system includes adapting a matchmaking capability of the game to incorporate the updating of the first rating and the updating of the second rating.

15. A non-transitory machine-readable storage medium storing a set of instructions that, when executed by at least one processor, causes the at least one processor to perform operations, the operations comprising:
improving a player rating system for a game networking system, the improving comprising:
identifying that events within a game corresponds to a combination of head-to-head mini games between a subset of a plurality of players of the game;
for each of the combinations of head-to-head mini games:
determine a result of the mini game; and
update first rating and a second rating based on the result of the mini game, the first rating corresponding to a first player and the second rating corresponding to the second player; and
adapt an aspect of the game networking system based on the updating of the first rating and the second rating.

16. The non-transitory machine-readable storage medium of claim 15, wherein the game is a poker game and the identifying that the events within the game correspond to a combination of head-to-head mini games is based on an identification that the subset of the plurality of players have placed a bet with respect to the game.

17. The non-transitory machine-readable storage medium of claim 16, wherein the determining of the result of the mini game is based on a determination that the first player has beaten the second player if the first player won chips and the second player lost chips, the second player has beaten the first player if the second player won chips and the first player lost chips.

18. The non-transitory machine-readable storage medium of claim 15, wherein the updating of the first rating and the updating of the second rating includes using a custom k-factor that incorporates at least one of a situational importance factor and overall importance factor.

19. The non-transitory machine-readable storage medium of claim 15, wherein the updating of the first rating and the updating of the second rating includes using a custom k-factor that incorporates a connection between different forms of the game.

20. The non-transitory machine-readable storage medium of claim 15, wherein the updating of the first rating and the updating of the second rating includes using a custom k-factor that incorporates a ratings-differential importance factor.
